(19) United States
(12) Patent Application Publication
(10) Pub. No.: US 2008/0038707 A1
(43) Pub. Date: Feb. 14, 2008

(54) Multi-modal learning system, apparatus, and method

(75) Inventors: Peter Banhazl, Wayland, MA (US); Martin Blumberg, Rockland, MA (US); David Werboff, Norfolk, MA (US)

Correspondence Address: Peter Banhazl, 18 Brook Trail Road, Wayland, MA, 01778, US

(73) Assignee: Sports LearningEdge LLC

(21) Appl. No.: 11/455,423

(22) Filed: Jun. 19, 2006

Related U.S. Application Data
(60) Provisional application No. 60/692,098, filed on Jun. 20, 2005.

(51) Int. Cl. G09B 3/00

(52) U.S. Cl. 434/350

(57) ABSTRACT

A system and method for creating and delivering multi-modal learning (instruction) from a single screen over connected and wireless networks, particularly the Internet.

Users can choose to learn how to perform a specific skill in the language and learning style that fits their needs and schedule. Instruction on the specific skill is presented in multiple components on a single web page that includes, at a minimum, an interactive animation executing the skill being performed, audio/video of the skill being performed in a real-life context, text-based instructions with voice-over on the basics steps of the skill, text-based tips and advice with voice-over on how to improve doing the skill, and interactive self assessments.

### CROSS-REFERENCE RELATED TO APPLICATIONS

This application claims the benefit of Provisional Patent No. 60/692,098, filed Jun. 20, 2005 by the present inventors.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to systems and methods for creating and delivering multi-modal learning (instruction) to a single screen over connected and wireless networks, particularly the Internet.

In today's information age, most people have access to online information over the Internet or other communications networks. While it is relatively easy to access volumes of information on virtually any subject, the information is typically not well organized in a way that makes it possible for most any user to quickly locate specific skills to select the learning style that best meets their specific learning needs.

The recent advent of e-Learning systems has helped to organize data and present it in a classroom-like environment. The traditional virtual classroom model cannot, however, structure the information in a fashion that delivers effective personalized learning to learners of different ages, languages, interests, and skill levels so that they can choose to learn specific skill elements in their own learning style and at their own pace and location.

Recent online methodologies created for teaching and business training utilize interactive multi-media to deliver user-modified learning to a well defined employee or classroom population are, by definition, limited in reach and technology. Although addressing the delivery of multi-media over the Internet addresses cognitive learning of tasks without physical execution required, the instruction presented is dependent on controlled learner feedback (U.S. Pat. No. 6,514,079) or for a learner physically interact with a delivered program to improve cognitive skills related to perform a physical skill better (U.S. Pat. App. No. 20060003298).

In order for learning to be of immediate value to today's learner, it must be accessible and be capable of addressing the Multiple Intelligences (“Intelligence Reframed: Multiple Intelligences for the 21^{st} Century” Howard Gardner, 1999) of learners of all ages and levels. Recent developments in online instruction for learning physical skills either require user interaction to generate controlled feedback or by Learners today are becoming accustomed to rapidly shifting their attention among multiple sources of information and having the choice to choose the modes that best suit them. With more than 1 billion people using the Internet worldwide, it becomes important to leverage this reach to share relevant skills instruction to as many people as possible.

The present invention specifically addresses the need to offer multiple learning styles by presenting the learner as many different ways to learn a specific skill and giving them to choice to select one or more. At a minimum, each skill delivered to a single screen will consist of instructional text and/or voice over deconstructing the skill, an interactive animation performing the skill in full, in reverse or connected to the basic steps, tips and advice on how to improve on the basic skills in text and/or voice over and a video or a real person executing the skill. The delivered skill learning will also provide the learner a choice of languages to read and hear the text in as well a built in self assessment by allowing manipulation of the delivered elements to reassemble the task learned.

### BRIEF SUMMARY OF THE INVENTION

In embodiments of the present invention, the learning experience is logically divided into a number of discrete content areas, or sub-topics, such as how to perform a particular physical skill. Information about each sub-topic consists of multiple components presented in various media, such as text, audio, video, and animation. The information may include, among other things, basic instructions presented as text with audio narration detailing the fundamental steps required to perform the skill; tips and advice presented as text with audio narration to support the basics by describing ways to improve performance of the skill; a visual example of the basic skill being performed presented as an interactive animation or graphic illustration which the learner can stop, replay, or manipulate in various ways; and an example of the skill being executed in a real-life environment to reinforce the basics, presented as a video or a series of still photographs (with or without audio narration). The use of different media allows different types of content to be presented in the most effective way and also serves to address users with different learning styles.

In an exemplary embodiment of the invention, a web-based application is used to organize the multiple components for presentation to, and access by, users via a four-panel display element, called a Skill Learning Module, which sits on a single web page. Through use of the Skill Learning Module, users have access to the different inter-related components in one location at the same time and can move from one to the other in unrestricted fashion to maximize the individual learning experience. Access to each Skill Learning Module is provided through a hierarchy of menus categorizing the various skills elements identified for the activity. The menu system is available on every web page to provide context within the overall learning structure and to simplify the navigation to related content areas. Delivery over the internet provides access virtually any time, anywhere, to maximize the availability of the learning experience.

There are many applications for the invention, including sports, cooking, dancing, and virtually any other performance-driven activity having specific skills to be learned.

Thus, in accordance with one aspect of the invention there is provided a method for providing, to a user over a network, multi-modal learning of subject matter. In exemplary embodiments of the invention, the method involves providing, to the user over the network, content in accordance with identified attributes of the subject matter. The content includes, with respect to each identified attribute of the subject matter, a web page offering at least (i) an abstracted visual representation of the attribute and (ii) a real-life visual representation of the attribute being executed in a real-life environment in the context of the subject matter. A related aspect of the invention involves a corresponding system for providing, to a user over a network, multi-modal learning of subject matter wherein the same content is provided in accordance with identified attributes of the subject matter. In embodiments of the invention, the abstracted visual representation may include an animation and/or a graphical illustration of the attribute, with or without accompanying audio. The real-life visual representation may include a video and/or a series of photographs, with or without accompanying audio.

In alternative or additional embodiments, the web page may offer additionally (iii) basic instructions detailing fundamental skills required to perform the attribute, and (iv) tips and advice to support the basics by showing ways to improve performance of the attribute. The basic instructions may be text-based, with or without accompanying audio. Similarly, the tips and advice may be text-based, with or without accompanying audio.

In such alternative or additional embodiments, the abstracted visual representation, real-life visual representation, basic instructions, and tips and advice may be presented in a quad configuration. In any case, the user is typically able to activate any of the components individually or concurrently.

In certain embodiments of the present invention, the subject matter relates to sports. In such embodiments, the attributes are typically skills that are associated with the sport. The abstracted visual representation typically shows a simulation of the skill being performed. The real-life visual representation typically shows an example of the skill being performed in a real-life environment. The basic instructions typically detail the fundamental steps required to perform the skill. The tips and advice typically support the basics by describing ways to improve performance of the skill.

The user may be provided with access to the web page over the network. Alternatively, or additionally, the user may be permitted to download the web page over the network for local access to the content. The content may be stored in a database and provided to the users by a server on the network.

### BRIEF DESCRIPTION OF THE DRAWINGS

The foregoing features of the invention will be more readily understood by reference to the accompanying drawings, in which:

FIG. 1 is a diagram of the technical hardware and software infrastructure for delivering on-demand learning in accordance with an embodiment of the present invention.

FIG. 2 is a diagram of the basic file structure of a LearningEdge Center, and specifically the basic web structure to deliver on-demand learning and specific skills learning elements to all available web-enabled devices, in accordance with an embodiment of the present invention.

FIG. 3 is a block diagram illustrating relevant components of a LearningEdge Center in accordance with an embodiment of the present invention.

FIG. 4 is a diagram representing an overview of a LearningEdge Center in accordance with an exemplary embodiment of the present invention.

FIG. 5 is a block diagram detailing a menu at the second level categorizing, organizing and labeling the path to access the specific skills learning modules in accordance with an exemplary embodiment of the present invention.

FIG. 6 is a diagram representing the content of a Skill Learning Module in accordance with an exemplary embodiment of the present invention.

FIG. 7 is a screenshot of a LearningEdge Center home page in accordance with an exemplary embodiment of the present invention.

FIG. 8 is a screenshot of a Chinese version of the LearningEdge Center home page.

FIG. 9 is a screenshot of a Spanish version of the LearningEdge Center home page.

FIG. 10 is a screenshot of a menu of attributes that is displayed when the user selects THE QUADS link from the main menu, in accordance with an exemplary embodiment of the present invention.

FIG. 11 is a screenshot of a sub-menu that is displayed when the SHOOTING link is selected from the attribute menu.

FIG. 12 is a screenshot of a page that is displayed when the JUMP SHOT link is selected from the SHOOTING attribute sub-menu.

FIG. 13 shows the menu of modules for the offensive jump shot attribute in accordance with an exemplary embodiment of the present invention.

FIG. 14 shows an exemplary Skill Learning Module that is displayed when the user selects THE RELEASE from the JUMP SHOT sub-menu.

FIG. 15 shows an exemplary Skill Learning Module that is displayed when the user selects the DEFENSE link.

FIG. 16 is a screenshot of a page that is displayed when the user selects ONLINE COACHING COURSES from the main menu, in accordance with an exemplary embodiment of the present invention.

FIG. 17 is a screenshot showing an exemplary syllabus for a youth basketball coaching course in accordance with an embodiment of the present invention.

FIG. 18 is a screenshot showing an exemplary coaching plan that is displayed when the user selects the “Coaching Plan” link from the screen shown in FIG. 17.

FIG. 19 is a screenshot showing an exemplary examination that is displayed when the user selects the “Exam” link from the screen shown in FIG. 18.

FIG. 20 is a screenshot of a page that is displayed when the user selects WHY THINGS REALLY WORK from the main menu, in accordance with an exemplary embodiment of the present invention.

FIG. 21 is a screenshot of a page that is displayed when the user selects TOMORROW'S LEGENDS from the main menu, in accordance with an exemplary embodiment of the present invention.

FIG. 22 is a screenshot of a page that is displayed when the user selects ANALYZE THIS from the main menu, in accordance with an exemplary embodiment of the present invention.

### DETAILED DESCRIPTION OF THE INVENTION

Definitions. As used in this description, including the preceding summary, the following terms shall have the meanings indicated, unless the context otherwise requires:

An “attribute” of subject matter is an element of performance in the area of the subject matter of the learning experience. For example, if the subject matter is basketball, the learning experience may be logically divided into specific skills such as shooting, dribbling, passing, etc.; shooting may be further divided into specific shots, such as the lay-up shot, the jump shot, the foul shot, the hook shot, etc.; the jump shot may be further divided into offensive and defensive perspectives; the offensive perspective of the jump shot may be further divided into specific motions, such as the release, the follow-through, etc.; and so on. Any or all of such elements, at any level of granularity, may be considered attributes of the learning experience.

An “abstracted visual representation” of an attribute is a visual representation of a simulation of the attribute being executed. For example, if the subject matter is basketball and the attribute is the jump shot, an abstracted visual representation may include, among other things, an animation or one or more graphic illustrations.

A “real-life visual representation” of an attribute is a visual representation of the attribute being executed in a real-life environment in the context of the subject matter. For example, if the subject matter is basketball and the attribute is the jump shot, a real-life visual representation may include, among other things, a video of a jump shot being executed in a game or series of photographs of a jump shot being executed in a game.

A “Skill Learning Module” is a web page providing access to information relating to a specific attribute, including at least an abstracted visual representation of the attribute and a real-life visual representation of the attribute. In exemplary embodiments of the present invention as discussed below, a Skill Learning Module typically provides access to four different types of information organized in a quad configuration.

Embodiments of the present invention provide an on-demand learning environment that allows users to access the specific skills instruction and supporting content they want, when and how they want it. In exemplary embodiments of the present invention, a learning experience is logically divided into a number of attributes, such as physical skills, activities, or steps. Information about each attribute is logically divided into multiple components of various media, such as text, audio, video, and animation. A web-based application (referred to hereinafter as the “LearningEdge Center”) is used to organize the multiple components for presentation to and access by users, typically (although not necessarily) through a single web page (referred to hereinafter as a “Skill Learning Module”). The LearningEdge Center can also include various other types of related information and services. Information can be tailored for different age groups, languages, and learning styles. Learning may be delivered directly to a user's screen via a multitude of technologies delivering Internet-based files, including modem, broadband, satellite, and other wired and wireless technologies. In this way, users have access to the multiple components at one location at virtually any time and from virtually anywhere.

In exemplary embodiments of the present invention, the Skill Learning Modules provides access to four different types of information for each attribute, specifically basics of the attribute (e.g., text and/or audio), quick tips (e.g., text and/or audio), interactive animation, and video (movie). The four different types of information are presented on a web page in a quad configuration. The Skill Learning Modules enable learners to access the information in the style best suited to their learning needs. Exemplary Skill Learning Modules are described in greater detail below.

Embodiments of the present invention can be configured to provide learning on a wide variety of subject matter, including, but in no way limited to, sports and other athletic activities, cooking and other culinary arts, knitting and other craftwork, dance and other physical activities, and building and other trades, to name but a few. Different perspectives can be provided for a particular attribute (e.g., information on a particular skill from both offensive and defensive perspectives or from both left-handed and right-handed perspectives, observing the skill in forward or reverse sequence, etc.).

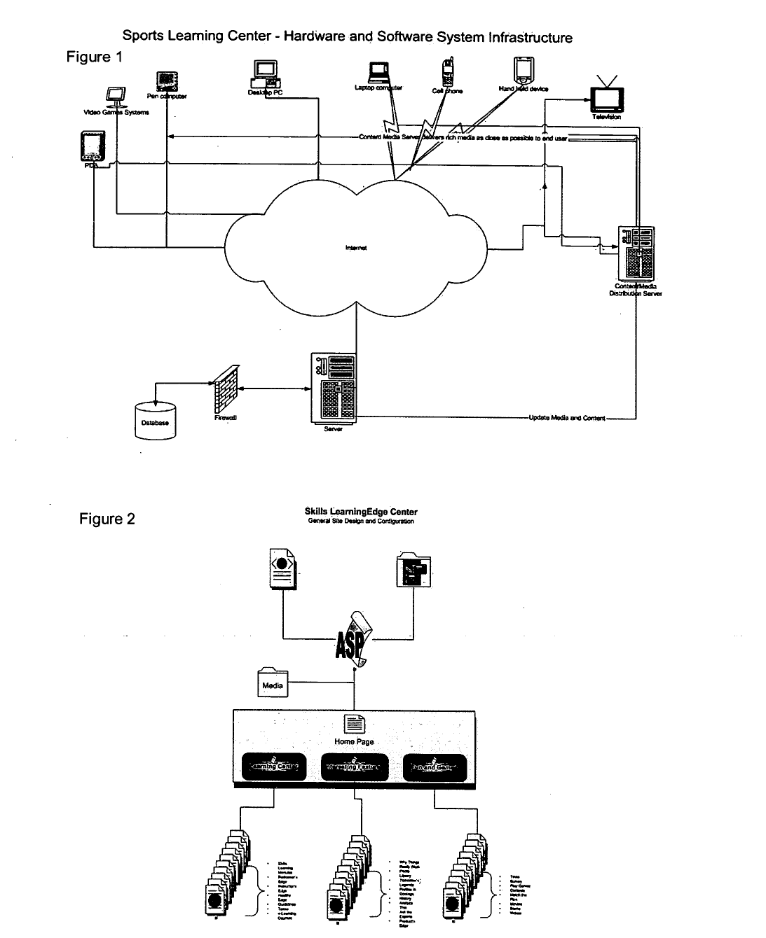

FIG. 1 is a diagram of the technical hardware and software infrastructure for delivering on-demand learning in accordance with an embodiment of the present invention. In this example, learning content can be provided from various servers to various types of user devices (e.g., PDAs, pen computers, desktop PCs, laptop computers, hand-held computer, wireless phones, etc.), for example, over the Internet or otherwise.

FIG. 2 is a diagram of the basic file structure of a LearningEdge Center, and specifically the basic web structure to deliver on-demand learning and specific skills learning elements, in accordance with an embodiment of the present invention. Content is typically stored in an XML file to facilitate translation and updating. External user data is typically stored in a relational database, protected by a firewall, where the users' personalized setting, communications, exams and registration information will reside. Media files (including video, audio, and graphics) are typically managed by a distributive content server to provide improved performance and access. To minimize demand on the client's system, all pages are typically rendered on the server using ASP.Net technology. When requested by a user, a home page is typically assembled and delivered. In an exemplary embodiment, the home page provides access to a learning center section, an interesting features section, and a fun and games section. The learning center typically provides links and content for specific attributes associated with the learning experience. The interesting features section typically provides links and content for information related to the learning experience. The fun and games section typically provides links and content for entertainment related to the learning experience.

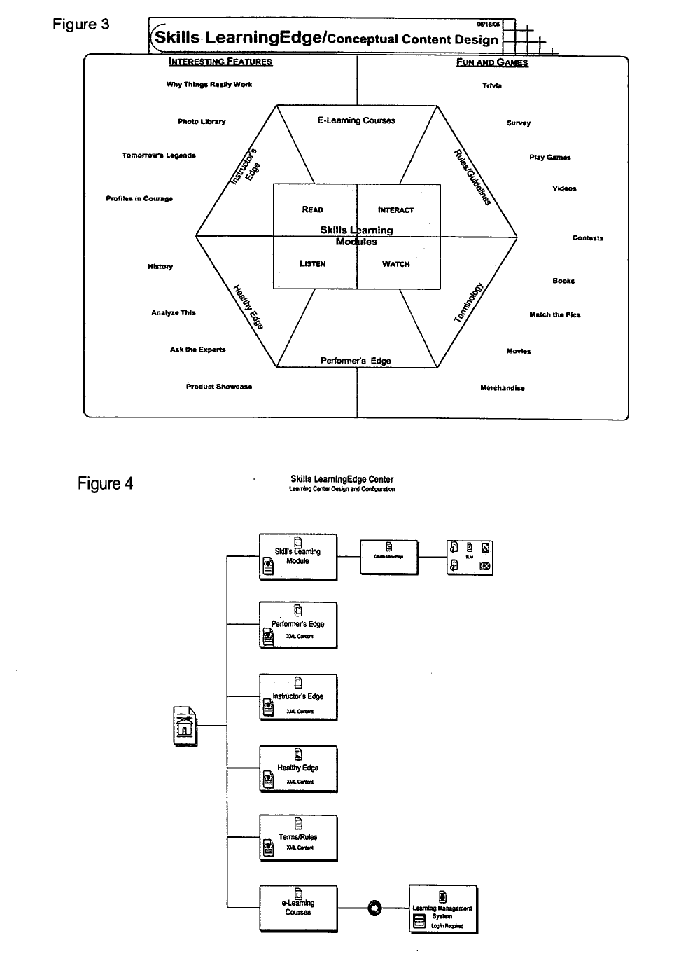

FIG. 3 is a block diagram illustrating relevant components of a LearningEdge Center in accordance with an embodiment of the present invention. In this example, the LearningEdge Center includes Skill Learning Modules through which core learning information is accessed. The LearningEdge Center typically also includes supplemental learning features (e.g., performer's edge, instructor's edge, healthy edge, terminology and rules) that may be accessed from the home page. The LearningEdge Center may also provide access to e-Learning courses, for example, through a learning management system. These and other features of an exemplary embodiment are discussed below.

FIG. 4 is a diagram representing an overview of a LearningEdge Center in accordance with an exemplary embodiment of the present invention. Among other things, the LearningEdge Center includes core skill elements, e-Learning courses, learning center features, interesting features, and fun & games features.

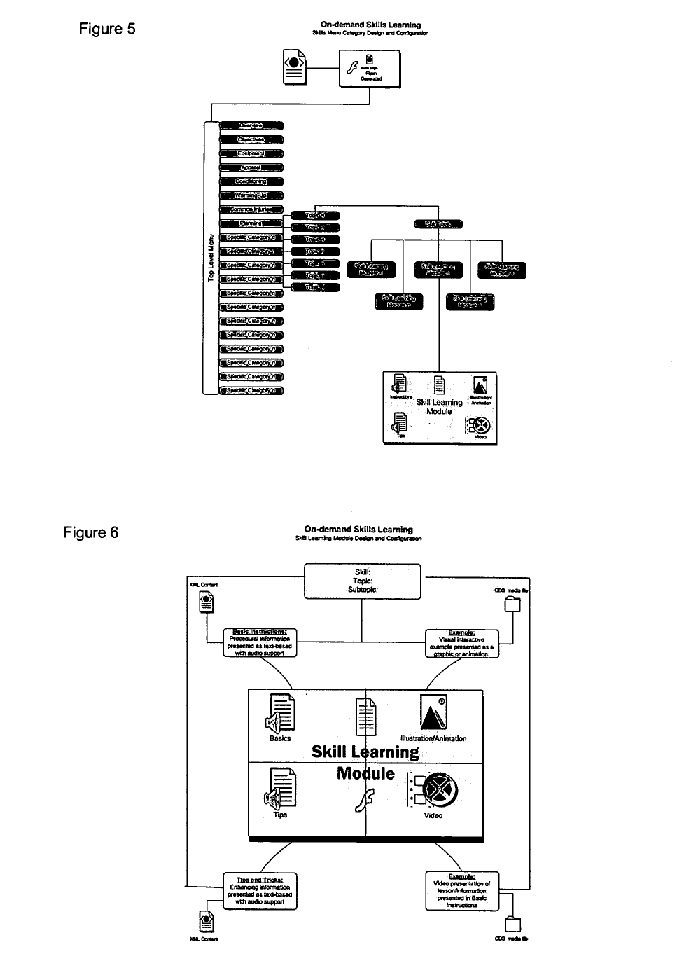

FIG. 5 is a block diagram detailing a menu at the second level categorizing, organizing and labeling the path to access the specific skills learning modules in accordance with an exemplary embodiment of the present invention. When a user requests access to the skills learning modules, an XML based menu and content is typically generated in Macromedia Flash. The menu lists the skill learning modules available and organizes them into related Categories. The categories are typically broken down even further into topics and then sub-topics, identifying the specific skills required to perform the topic. Each sub-topic is typically broken down by the elements of that skill and then delivered in a Skill Learning Module specific to that skill.

FIG. 6 is a diagram representing the content of a Skill Learning Module in accordance with an exemplary embodiment of the present invention. This diagram depicts the learning methodology and elements of a single-screen Skill Learning Module. The skill chosen (in this example, the release motion of shooting a jump shot in basketball) is typically compiled and presented in a Macromedia Flash file assembled from XML content and CDS Media files for presentation on a single screen. The four main components of a skill learning module may be accessed individually or concurrently. Text may be read and/or listened to in a chosen language. Graphics and photos may be viewed, animations may be interacted with, and video clips may be watched and listened to. Each Skill Learning Module typically delivers the skills elements as follows: basic instructions are presented as text with audio narration detailing the fundamental skills required to perform the skill; tips and advice are presented as text with audio narration to support the basics by showing ways to improve performance of the skill; a visual example of the basic skill being performed is presented as an interactive animation or graphic illustration; and a video example or a series of still photographs of the skill being executed in a real-life environment (with or without audio) is presented to reinforce basics. By delivering the elements specific to a skill in multi-modal fashion, the user can access the information in the way best suited to their learning needs and desires. A user may revisit the skill learning module during or after performing the skill to acquire additional learning to improve their performance of the skill.

Exemplary embodiments are described below with reference to learning basketball skills, although it will be apparent that the described techniques can be applied to other subjects. Thus, the present invention is not limited to basketball or to any particular subject matter.

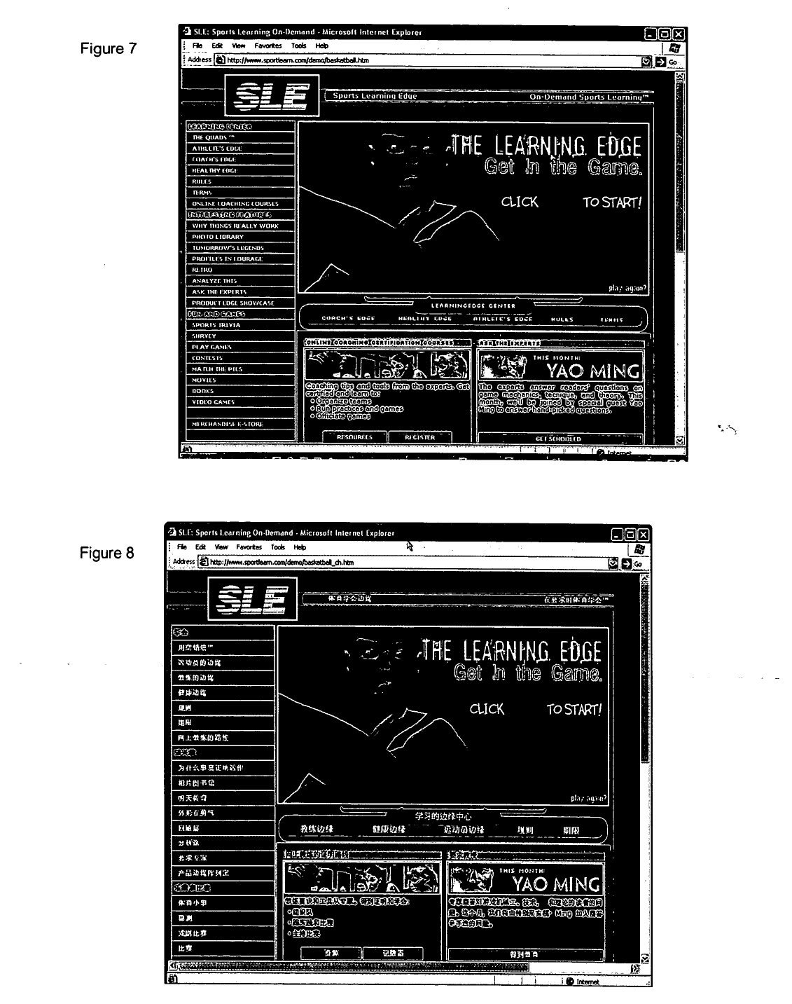

FIG. 7 is a screenshot of a LearningEdge Center home page in accordance with an exemplary embodiment of the present invention. In order to access the LearningEdge Center, the user typically enters an appropriate URL and domain name for the site in an appropriate web browser. A LearningEdge Center home page is displayed to the user. The LearningEdge Center home page allows the user to select a language, currently from a list of languages shown at the bottom of the home page.

Among other things, the LearningEdge Center home page includes a Main Menu of user-selectable links along the left side of the screen. The main menu is divided into three sections, namely LEARNING CENTER, INTERESTING FEATURES, and FUN AND GAMES. Links in the LEARNING CENTER section provide access to learning resources related to the activity. Links in the INTERESTING FEATURES section provide access to ancillary information about the activity. Links in the FUN AND GAMES section provide access to various features intended to keep the user engaged on the site.

The LEARNING CENTER section includes links entitled THE QUADS, ATHLETE'S EDGE, COACH'S EDGE, HEALTHY EDGE, RULES, TERMS, and ONLINE COACHING COURSES. THE QUADS link brings the user to a page including a menu of attributes associated with the selected learning experience (described below), from which the user can access Skill Learning Modules. The ATHLETE'S EDGE link brings the user to a page that might include relevant articles on topics such as conditioning, psychology, philosophy, nutrition, and “advice of the trade” that could help the user improve and have more fun in the learned activity. The COACH'S EDGE link brings the user to a page that might include information regarding coaching and officiating, such as interesting articles from experts regarding the knowledge and resources necessary to run practices and games and understand sports psychology, conditioning, drills, plays and how to make learning to play an exciting and enriching experience. The HEALTHY EDGE link brings the user to a page that might include information for keeping healthy while preparing for and engaging in the activity. The RULES link brings the user to a page that might include rules and regulations for the activity. The TERMS link brings the user to a page the might include terminology relating to the activity. The ONLINE COACHING COURSES link brings the user to a page that might include informational e-learning resources, such as coaching certification courses, drills, private notes, peer-to-peer email and chat, threaded discussions, downloads, and exams.

The INTERESTING FEATURES section includes links entitled WHY THINGS REALLY WORK, PHOTO LIBRARY, TOMORROW'S LEGENDS, PROFILES IN COURAGE, RETRO, ANALYZE THIS, ASK THE EXPERTS, and PRODUCT EDGE SHOWCASE. The WHY THINGS REALLY WORK link brings the user to a page that might include information about how things work, such as, for example, how a curveball curves. The PHOTO LIBRARY link brings the user to a page that might include photographs related to the activity, such as, for example, photographs of players. The TOMORROW'S LEGENDS link brings the user to a page that might include information about up-coming stars. The PROFILES IN COURAGE link brings the user to a page that might include interesting stories about people overcoming hardships to become someone special. The RETRO link brings the user to a page that might include information about the history and past participants in the activity. The ANALYZE THIS link brings the user to a page that might include scenarios that the user can analyze. The ASK THE EXPERTS link brings the user to a page that might include tips from experts as well as a portal through which the user can pose questions to an expert in the activity. The PRODUCT EDGE SHOWCASE link brings the user to a page that might include information about specific products and equipment related to the activity.

The FUN AND GAMES section includes links entitled SPORTS TRIVIA, SURVEY, PLAY GAMES, CONTESTS, MATCH THE PICS, MOVIES, BOOKS, VIDEO GAMES, and MERCHANDISE E-STORE. The SPORTS TRIVIA link brings the user to a page that might include trivia related to the activity. The SURVEY link brings the user to a page that might include an on-line survey related to the activity. The PLAY GAMES link brings the user to a page that might include games related to the activity. The CONTESTS link brings the user to a page that might include contests related to the activity such as, for example, trivia games. The MATCH THE PICS link brings the user to a page that might include picture matching activities such as, for example, trying to locate 10-12 differences between two seemingly identical pictures. The MOVIES link brings the user to a page that might include information about movies related to the activity. The BOOKS link brings the user to a page that might include information about books related to the activity. The VIDEO GAMES link brings the user to a page that might include information about video games related to the activity. The MERCHANDISE E-STORE brings the user to an on-line store that sells merchandise relating to the activity.

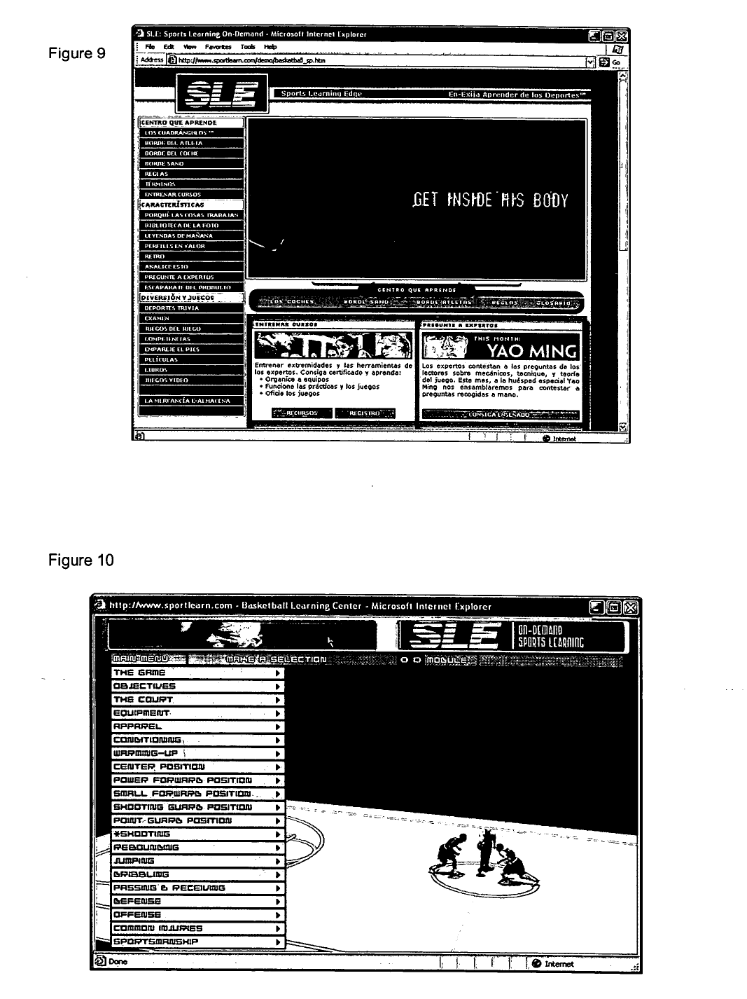

As discussed above, the LearningEdge Center can provide information in different languages. FIG. 8 is a screenshot of a Chinese version of the LearningEdge Center home page. FIG. 9 is a screenshot of a Spanish version of the LearningEdge Center home page. The translation process is facilitated by the storing all content in external XML files. This technique reduces the level of effort required to translate the site and allows for easy customization to account for cultural differences.

As discussed above, when the user selects THE QUADS link from the main menu, the user is brought to a page including a menu of attributes associated with the selected learning experience (described below), from which the user can access Skill Learning Modules. FIG. 10 is a screenshot of a menu of attributes that is displayed when the user selects THE QUADS link from the main menu, in accordance with an exemplary embodiment of the present invention. In this basketball example, the attributes include THE GAME, OBJECTIVES, THE COURT, EQUIPMENT, APPAREL, CONDITIONING, WARMING-UP, CENTER POSITION, POWER FORWARD POSITION, SMALL FORWARD POSITION, SHOOTING GUARD POSITION, POINT GUARD POSITION, SHOOTING, REBOUNDING, JUMPING, DRIBBLING, PASSING & RECEIVING, DEFENSE, OFFENSE, COMMON INJURIES, and SPORTSMANSHIP.

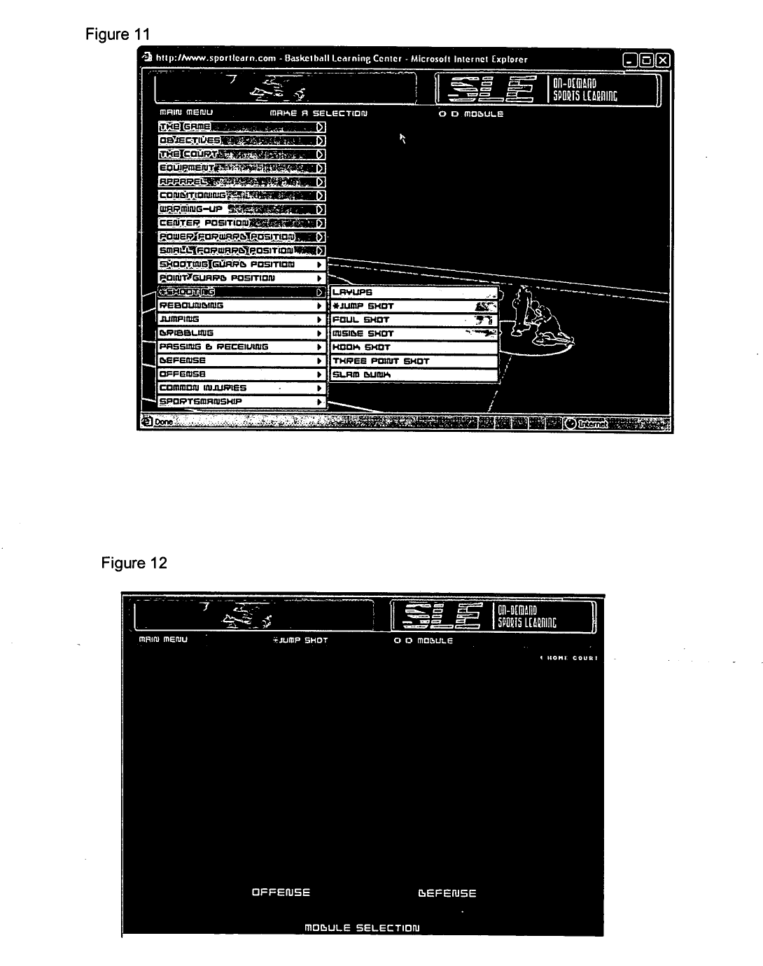

FIG. 11 is a screenshot of a sub-menu that is displayed when the SHOOTING link is selected from the attribute menu. This sub-menu lists links for shooting-specific attributes, including LAYUPS, JUMP SHOT, FOUL SHOT, INSIDE SHOT, HOOK SHOT, THREE POINT SHOT, and SLAM DUNK.

FIG. 12 is a screenshot of a page that is displayed when the JUMP SHOT link is selected from the SHOOTING attribute sub-menu, which, in this example, allows the user to choose to learn about jump shots from either an offensive perspective (e.g., shooting the jump shot) or a defensive perspective (e.g., defending the jump shot).

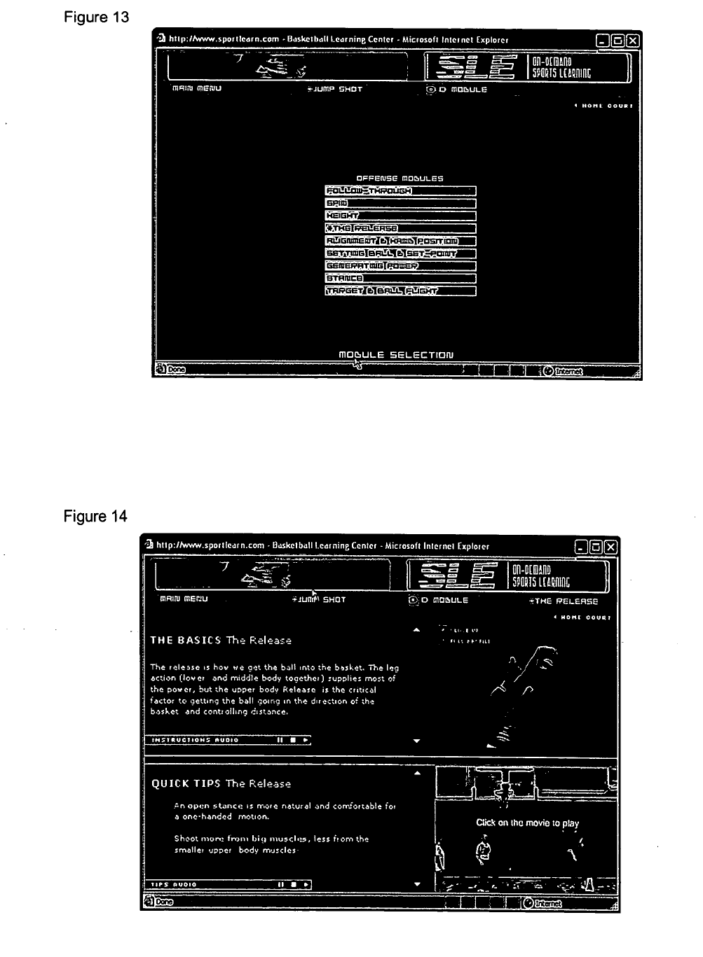

If the user selects the OFFENSE link, then a menu of modules for the offensive perspective of the jump shot attribute is displayed to the user. FIG. 13 shows the menu of modules for the offensive jump shot attribute in accordance with an exemplary embodiment of the present invention. This menu includes links for modules entitled FOLLOW-THROUGH, SPIN, HEIGHT, THE RELEASE, ALIGNMENT & HANG POSITION, SETTING BALL & SET-POINT, GENERATING POWER, STANCE, and TARGET & BALL FLIGHT.

FIG. 14 shows an exemplary Skill Learning Module that is displayed when the user selects THE RELEASE link from the menu. The Skill Learning Module includes information presented in four quadrants, including basic instructions for the jump shot release, presented as text with audio support detailing the fundamental skills required to perform the skill; quick tips discussing ways to improve performance of the jump shot release to bolster or support the basics, presented as text with audio; a visual example of the basic skill being performed, presented as an interactive animation or graphic illustration; and a visual example of the jump shot release being executed in a real-life environment (e.g., by a professional), presented as a video or series of still photographs, optionally including audio.

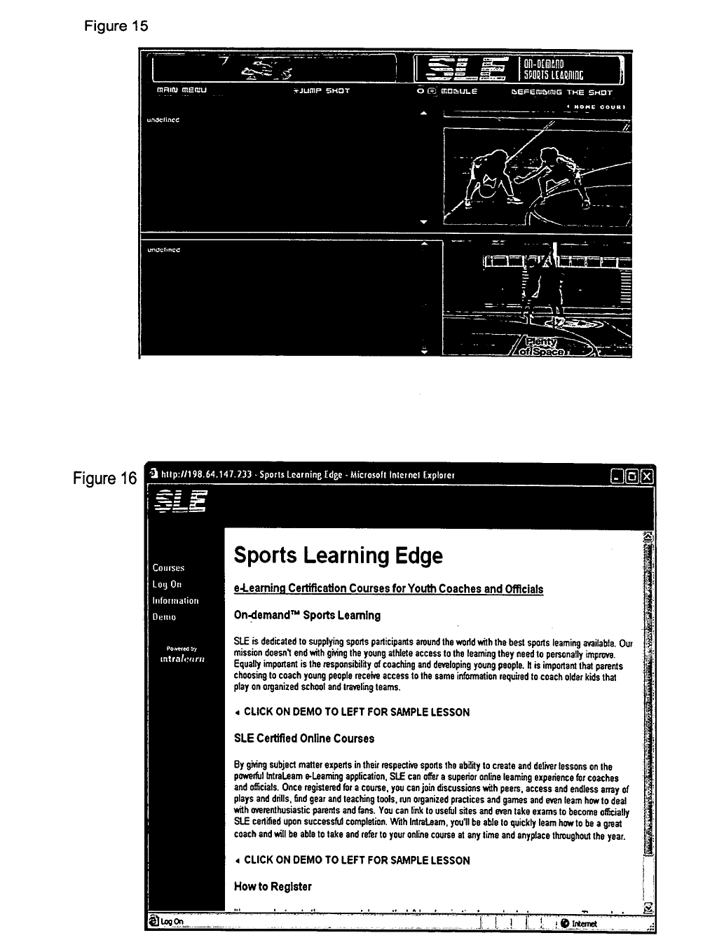

If the user selects the DEFENSE link, then a Skill Learning Module for the defensive perspective of the jump shot attribute is displayed to the user. FIG. 15 shows an exemplary Skill Learning Module that is displayed when the user selects the DEFENSE link. The Skill Learning Module includes information presented in four quadrants, including basic instructions for defending the jump shot, presented as text with audio support detailing the fundamental skills required to perform the skill; quick tips discussing ways to improve performance of the activity, presented as text with audio; a visual example of the basic skill being performed, presented as an interactive animation or graphic illustration; and a visual example of the defending the jump shot being executed in a real-life environment (e.g., by a professional), presented as a video or series of still photographs, optionally including audio.

FIG. 16 is a screenshot of a page that is displayed when the user selects ONLINE COACHING COURSES from the main menu, in accordance with an exemplary embodiment of the present invention. This screen provides access to various online coaching courses and resources.

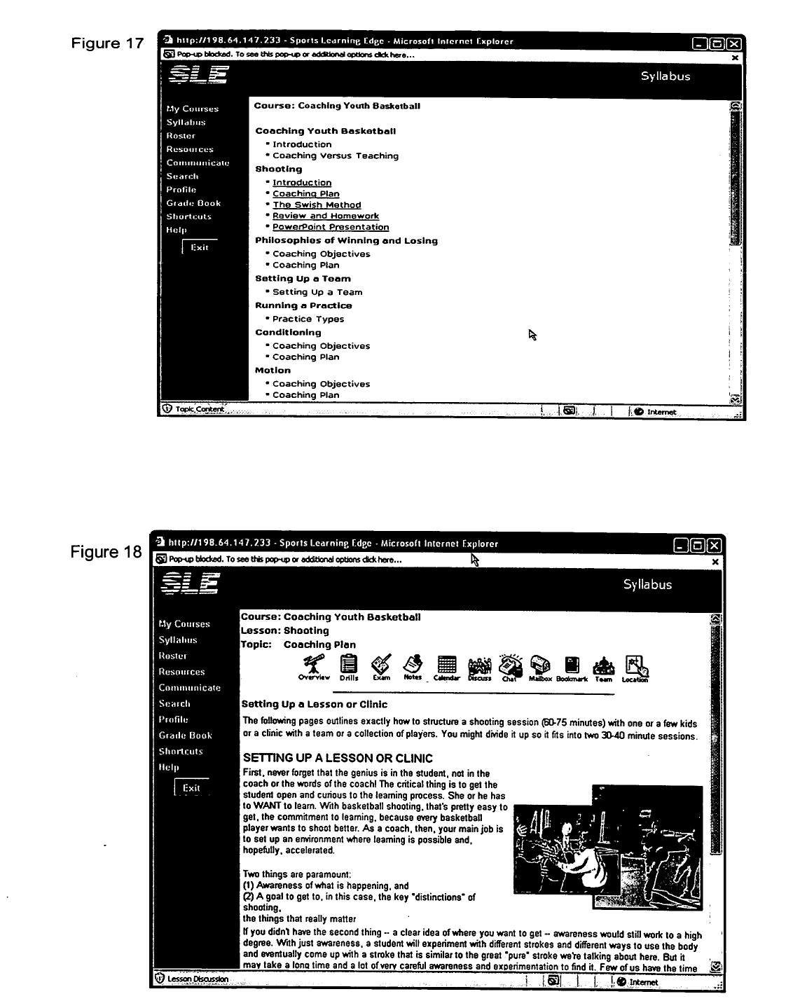

FIG. 17 is a screenshot showing an exemplary syllabus for a youth basketball coaching course in accordance with an embodiment of the present invention.

FIG. 18 is a screenshot showing an exemplary coaching plan that is displayed when the user selects the “Coaching Plan” link from the screen shown in FIG. 17.

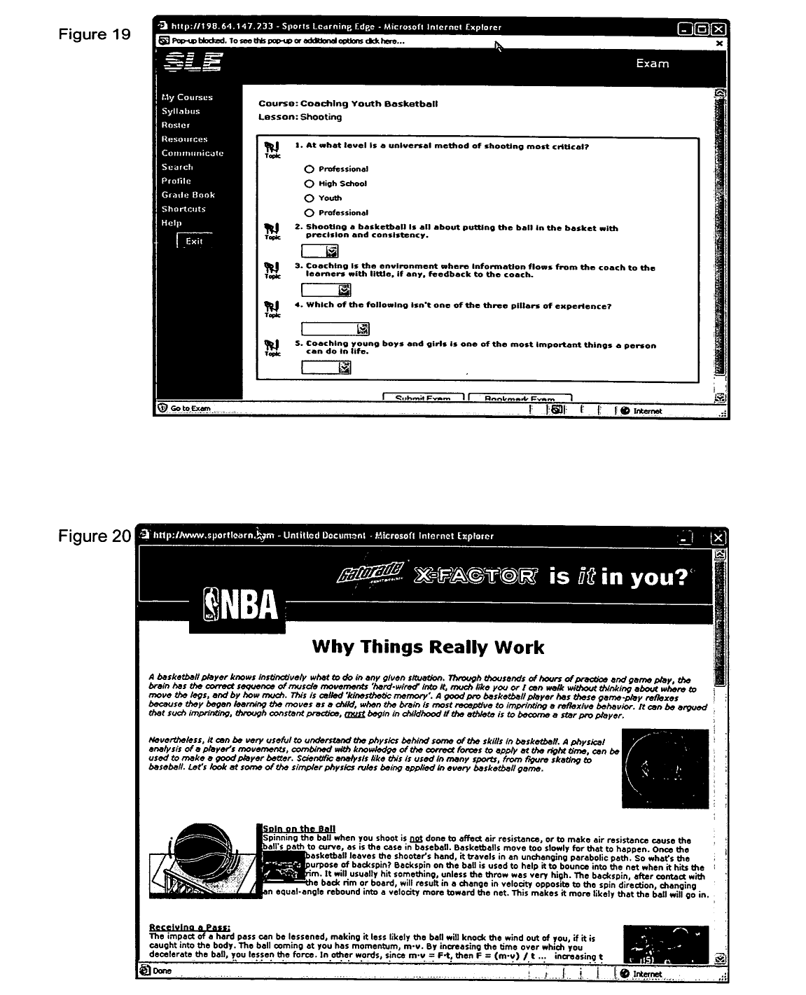

FIG. 19 is a screenshot showing an exemplary examination that is displayed when the user selects the “Exam” link from the screen shown in FIG. 18. A coach might be required to pass such an examination in order to receive a coaching certification.

FIG. 20 is a screenshot of a page that is displayed when the user selects WHY THINGS REALLY WORK from the main menu, in accordance with an exemplary embodiment of the present invention. This screenshot provides explanations for the physics behind various skills, such as the purpose of backspin on the ball and the physics of receiving a pass.

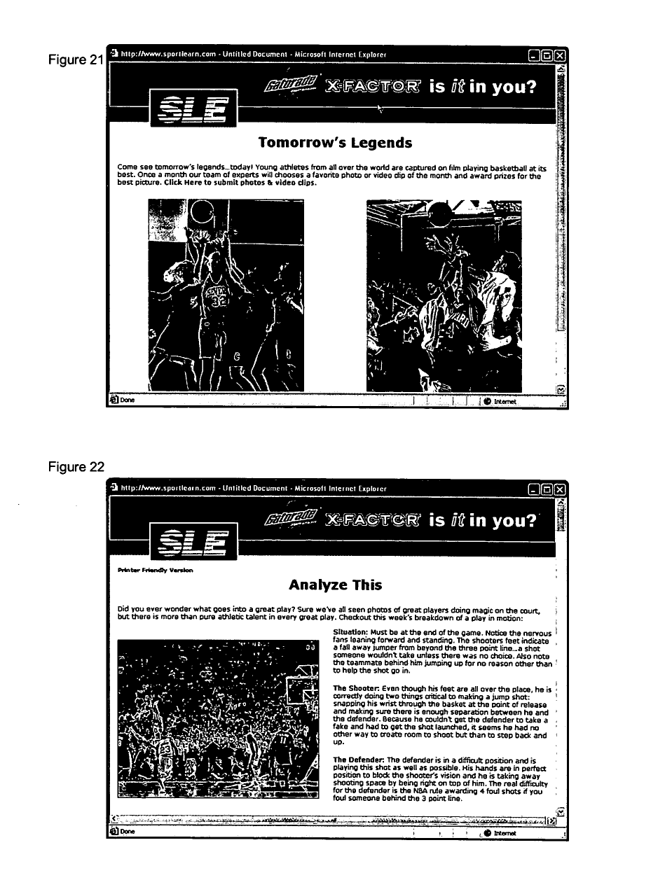

FIG. 21 is a screenshot of a page that is displayed when the user selects TOMORROW'S LEGENDS from the main menu, in accordance with an exemplary embodiment of the present invention. This screenshot presents videos of young athletes in action.

FIG. 22 is a screenshot of a page that is displayed when the user selects ANALYZE THIS from the main menu, in accordance with an exemplary embodiment of the present invention. This screenshot presents a breakdown of a play in motion, specifically detailing the situation, the actions of the shooter, and the actions of the defender.

In the above example, a basketball learning experience was divided into a number of attributes that were presented in a hierarchy (e.g., the main menu after selecting THE QUADS link, the sub-menu after selecting the SHOOTING link, the OFFENSE/DEFENSE menu, the modules after selecting OFFENSE). Among other things, such a hierarchy facilitates access by users.

Although multi-modal learning information may be organized and presented in the form of a quad, the present invention is not limited to such organization and presentation. Such information can be organized and presented in other forms. Furthermore, access to such information can be provided from a single web page or multiple web pages.

Various aspects of the present invention were described above with reference to an exemplary basketball learning system. It will be apparent, however, that similar techniques can be used for other learning subjects and environments.

The present invention may be embodied in other specific forms without departing from the true scope of the invention. The described embodiments are to be considered in all respects only as illustrative and not restrictive.

What is claimed is:

1. A multi-modal learning system for teaching individual skills in which a learning experience is divided into a number of attributes, the system comprising: (a) providing, to the user over the network, content in accordance with identified attributes of the subject matter; (b) such content including, with respect to each identified attribute of the subject matter, a single web page offering at least (c) an abstracted visual representation of the attribute; (d) a real-life visual representation of the attribute being executed in a real-life environment in the context of the subject matter; (e) text relative to understanding the subject matter; (f) audio available to support the learning and; (g) self-assessment capabilities.

2. A multi-modal learning system according to claim 1, wherein a server coupled to the database and to a communication network for interactive communication with a number of users, wherein the server provides the information to multiple users over the communication network.

3. A multi-modal learning system according to claim 1, wherein visual representation includes an animation.

4. A multi-modal learning system according to claim 1, wherein visual representation includes a graphic illustration.

5. A multi-modal learning system according to claim 1, wherein the example of the attribute being executed in a real-life environment includes a video.

6. A multi-modal learning system according to claim 1, wherein the example of the attribute being executed in a real-life environment includes a series of photographs.

7. A multi-modal learning system according to claim 1, wherein the components include text-based instruction relating to the attribute.

8. A multi-modal learning system according to claim 7, wherein the text-based components further include the basic instructions detailing fundamental skills required to perform the attribute.

9. A multi-modal learning system according to claim 7, wherein the text-based instruction includes tips to support the basics by showing ways to improve performance of the attribute.

10. A multi-modal learning system according to claim 7, wherein the text-based components are further supported by audio.

11. A multi-modal learning system according to claim 7, wherein the text-based components may be presented in more than one international language.

12. A multi-modal learning system according to claim 1 and 7, wherein the server provides the components on a single page.

13. A multi-modal learning system according to claim 12, wherein the server allows the users to activate any of the components.

14. A multi-modal learning system according to claim 13, wherein the server presents the components in a quad configuration on the single page, the quad configuration including quadrants for the visual representation, the example of the attribute being executed in a real-life environment, the basic instructions, and the tips and advice.

15. A multi-modal learning system according to claim 14, wherein certain components are synchronized and linked to enhance the learning experience.

16. A multi-modal learning system according to claim 14, wherein components may be manipulated for self assessment purposes.

17. A multi-modal learning system according to claim 14, wherein the server allows the users to activate any of the components.

18. A multi-modal learning system according to claim 1, wherein the server permits interactive access to the components over the communication network.

19. A multi-modal learning system according to claim 1, wherein the server permits viewing the components over the communications network, including the Internet, for immediate local access.
